(19) United States
(12) Patent Application Publication
(10) Pub. No.: US 2021/0062064 A1
(43) Pub. Date: Mar. 4, 2021

(54) HIGH TEMPERATURE TREATMENT FLUID WITH NANOCELLULOSE

(71) Applicant: Halliburton Energy Services, Inc., Houston, TX (US)

(72) Inventors: Jay Paul Deville, Spring, TX (US); Ayten Khaled Rady, Houston, TX (US); Catherine Martin Santos, Houston, TX (US); Bill Zhou, The Woodlands, TX (US)

(21) Appl. No.: 16/500,000

(22) PCT Filed: Nov. 19, 2018
(86) PCT No.: PCT/US2018/061827

§ 371 Date: Oct. 1, 2019

(51) Int. Cl. C09K 8/10; C09K 8/514; C09K 8/512; C09K 8/504; C09K 8/12; E21B 21/00; E21B 43/26

(52) U.S. Cl. CPC C09K 8/10; C09K 8/514; C09K 8/512; C09K 2208/10; C09K 8/12; E21B 21/003; E21B 43/26; C09K 8/5045

(57) ABSTRACT

A method of using a high temperature treatment fluid containing nanocellulose including: providing a treatment fluid that includes a base fluid, a synthetic crosslinked polymer composition including a plurality of monomeric units, and at least one crosslinker, and a nanocellulose. The treatment fluid is introduced into at least a portion of a well bore penetrating at least a portion of a subterranean formation.

### BACKGROUND

The present disclosure relates to the field of producing crude oil or natural gas from subterranean formations. More specifically, the present disclosure generally relates to compositions of synthetic crosslinked polymers with nanocellulose, and methods of using such compositions as viscosifiers and fluid-loss control additives in drilling and treatment fluids for subterranean applications.

Treatment fluids can be used in a variety of subterranean treatment operations. As used herein, the terms “treat,” “treatment,” “treating,” and grammatical equivalents thereof refer to any subterranean operation that uses a fluid in conjunction with achieving a desired function and/or for a desired purpose. Use of these terms does not imply any particular action by the treatment fluid. Illustrative treatment operations can include, for example, fracturing operations, gravel packing operations, acidizing operations, scale dissolution and removal, consolidation operations, and the like. For example, a fluid may be used to drill a well bore in a subterranean formation or to complete a well bore in a subterranean formation, as well as numerous other purposes. A drilling fluid, or “mud” which a drilling fluid is also often called, is a treatment fluid that is circulated in a well bore as the well bore is being drilled to facilitate the drilling operation. The various functions of a drilling fluid include removing drill cuttings from the well bore, cooling and lubricating the drill bit, aiding in support of the drill pipe and drill bit, and providing a hydrostatic head to maintain the integrity of the well bore walls and prevent well blowouts.

A treatment fluid typically includes water and/or oil, synthetic oil, or other synthetic material or fluid as a base fluid. A number of additives may be included in such drilling fluids to improve certain properties of the fluid. Such additives may include, for example, emulsifiers, weighting agents, fluid-loss additives or fluid-loss control agents, viscosifiers or viscosity control agents, and alkali. Fluid loss typically refers to the undesirable leakage of a fluid phase of any type of fluid into the permeable matrix of a zone, which zone may or may not be a treatment zone. Fluid-loss control refers to treatments, additives, and/or materials designed or used to reduce such undesirable leakage.

Certain synthetic polymers for water-based drilling fluids that offer desired rheology control as well as fluid-loss control for high-temperature applications up to 260° C. (500° F.) have been developed. These polymers are generally linear or lightly crosslinked and need to be used with clay to achieve desired viscosity and fluid-loss control. These synthetic polymers may serve as viscosifiers and fluid loss control agents for high temperature drilling operations. However, certain of these synthetic polymers for water-based drilling fluids have low initial rheology upon mixing and prior to exposure to higher temperatures within a formation. The low initial rheology can cause particulates and other materials to settle out of the fluid.

### BRIEF DESCRIPTION OF THE DRAWINGS

These drawings illustrate certain aspects of some of the embodiments of the present disclosure, and should not be used to limit or define the claims.

FIG. 1 is a diagram illustrating an example of a well bore drilling assembly that may be used in accordance with certain embodiments of the present disclosure.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DESCRIPTION OF CERTAIN EMBODIMENTS

The present disclosure relates to compositions and methods for use in subterranean formations, and more specifically, the present disclosure generally relates to compositions including synthetic crosslinked polymers and nanocellulose and methods of using such compositions as viscosifiers and fluid-loss control additives in drilling and treatment fluids for subterranean applications.

The methods and compositions of the present disclosure generally involve a base fluid, a synthetic crosslinked polymer composition, and nanocellulose. The synthetic crosslinked polymer compositions can include (a) one or more polymers that include a plurality of monomeric units and (b) a crosslinker. The methods and compositions of the present disclosure may be used in any operation or treatment in a subterranean formation (e.g., a well bore penetrating at least a portion of a subterranean formation). In some embodiments, the methods and compositions of the present disclosure may be used in conjunction with subterranean drilling operations. In certain embodiments, the methods of the present disclosure may include providing a treatment fluid including a base fluid, nanocellulose, and a synthetic crosslinked polymer composition including at least one polymer that includes a plurality of monomeric units, and at least one crosslinker selected from the group consisting of: an acrylamide-based crosslinker, an acrylate-based crosslinker, an ester-based crosslinker, an amide-based crosslinker, divinyl ether, diallyl ether, vinyl or allyl ethers of polyglycols or polyols, divinylbenzene, 1,3-divinylimidazolidin-2-one, divinyltetrahydropyrimidin-2(1H)-one, diener, allyl amines, N-vinyl-3(E)-ethylidene pyrrolidone, ethylidene bis(N-vinylpyrrolidone), and any combination thereof, and introducing the treatment fluid into at least a portion of a wellbore penetrating at least a portion of a subterranean formation.

The treatment fluids of the present disclosure generally include a base fluid, which may include any fluid known in the art, including aqueous fluids, non-aqueous fluids, gases, or any combination thereof. Aqueous fluids that may be suitable for use in the methods and systems of the present disclosure may include water from any source, provided that it does not contain compounds that adversely affect other components of the treatment fluid. Such aqueous fluids may include fresh water, salt water (e.g., water containing one or more salts dissolved therein), brine, salt water, seawater, or any combination thereof. In certain embodiments, the density of the aqueous fluid can be adjusted, among other purposes, to provide additional particulate transport and suspension in the compositions of the present disclosure. In certain embodiments, the pH of the aqueous fluid may be adjusted (e.g., by a buffer or other pH adjusting agent) to a specific level, which may depend on, among other factors, the types of gelling agents, acids, and other additives included in the fluid. One of ordinary skill in the art, with the benefit of this disclosure, will recognize when such density and/or pH adjustments are appropriate. Examples of non-aqueous fluids that may be suitable for use in the methods and systems of the present disclosure include, but are not limited to, oils, hydrocarbons, organic liquids, alcohols, (e.g., glycols), polar solvents, and the like. In certain embodiments, the treatment fluids may include a mixture of one or more fluids and/or gases, including but not limited to emulsions, foams, and the like.

In certain embodiments, an aqueous base fluid according to the present disclosure may include water with one or more water-soluble salts dissolved therein. In certain embodiments of the present disclosure, the one or more salts can be selected from the group of inorganic salts, formate salts, or any combination thereof. Inorganic salts can be selected from the group of monovalent salts, which can be further selected from the group consisting of: alkali metal halides, ammonium halides, and any combination thereof. Inorganic salts can also be selected from the group of divalent salts, such as alkaline earth metal halides (e.g., CaCl2, CaBr2, etc.) and zinc halides. Brines including such divalent salts may be referred to as “divalent brines.” Monovalent salts can be used to form drilling or treatment fluids having an aqueous phase having a density up to about 12.5 lb/gal. Brines including monovalent salts may be referred to as “monovalent brines.” Brines including halide-based salts may be referred to as “halide-based brines.”

The treatment fluids of the present disclosure may include nanocellulose. In some embodiments, the nanocellulose may be used as a sacrificial viscosifier in order to increase the initial rheology of the treatment fluids. The increase in initial shear rheology of the treatment fluid provided by the nanocellulose may prevent settling out of calcium carbonate and other particulates that may be included within the drilling or treatment fluid for transport into the wellbore. The nanocellulose of the present disclosure may be provided in many forms, including but not limited to, nanofibrillar cellulose, nanocrystalline cellulose, and bacterial nanocellulose. In an alternative embodiment, microfibrillar cellulose could be included in the treatment fluid. In some embodiments, the nanocellulose has a diameter of about 3 nm to about 10 nm. In some embodiments, the nanocellulose has a diameter of about 20 nm to about 40 nm. In some embodiments according to the present disclosure, the diameter of the nanocellulose should not exceed 200 nm.

In some embodiments, the nanocellulose can be chemically modified for improved performance. For example, in some embodiments, functional groups, such as polyethylene oxide, polypropylene oxide, carboxylic, amines, amides, esters, and sulfonates, can be incorporated into the nanocelluloses.

The nanocellulose of the present disclosure may come from a variety of sources, including but not limited to cotton, wood, woodpulp, sisal, hemp, flax, and other plants. Furthermore, the nanocellulose of the present disclosure may come from bacterial-produced cellulose. In some embodiments, the nanocellulose can be obtained from the various sources by shearing microfibrils or bundles of cellulose in order to isolate smaller fibers.

In certain embodiments of the present disclosure, the concentration of nanocellulose in the treatment fluid can be varied to impart the desired rheological properties. In some embodiments, the concentration of nanocellulose in a treatment fluid containing the synthetic polymers of the present disclosure may be from about 0.6 pounds per barrel (lb/bbl) to about 1 lb/bbl. In some embodiments, the concentration of nanocellulose in a treatment fluid containing the synthetic polymers of the present disclosure may be from about 0.7 lb/bbl to about 1 lb/bbl. In some embodiments, the concentration of nanocellulose in a treatment fluid containing the synthetic polymers of the present disclosure may be from about 0.7 lb/bbl to about 0.9 lb/bbl.

In certain embodiments of the present disclosure, the base fluid includes a divalent brine. When used with the polymers according to the present disclosure, nanocellulose may impart an improved increase in rheology to a treatment fluid at low temperatures in a divalent brine as compared to a monovalent brine.

In some embodiments, when introduced into the wellbore and exposed to heat, the nanocellulose within the treatment fluid at least partially degrades. In some embodiments, the nanocellulose at least partially degrades around 325° F. Upon degradation, the nanocellulose no longer significantly contributes to the rheology of the treatment fluid. In some embodiments, the nanocellulose increases the shear rheology of the treatment fluid initially after mixing and prior to exposure to heat. After heat exposure, the synthetic polymers of the present disclosure may increase the rheology of the fluid, and the nanocellulose may at least partially degrade and cease significantly increasing the rheology of the fluid. Therefore, in certain embodiments of the present disclosure, the combination of the nanocellulose and the synthetic polymers may provide a consistent rheology to a treatment fluid prior to and upon introduction of the fluid into a wellbore and the heating of the fluid.

The polymers used in the methods and compositions of the present disclosure may include any synthetic polymeric material that includes a plurality of monomeric units. In some embodiments, the synthetic polymeric material may include at least one type of monomeric unit, such as N-vinyl lactam, or any derivatives thereof. As used herein, “derivative” means a chemical compound formed by a chemical process from a parent compound, wherein the chemical backbone skeleton of the parent compound is retained in the derivative. The chemical process may include only a few chemical reaction steps, and in some instances only one or two chemical reaction steps. Such polymers may be homopolymers (e.g., polyvinylpyrrolidone (PVP)) or copolymers, terpolymers, tetrapolymers, etc. of one or more N-vinyl lactam monomers with one or other monomers. In certain embodiments, the monomeric units include at least about 5 mol % of N-vinyl lactam monomeric units of the polymer. In certain embodiments, the N-vinyl lactam monomeric units include about 30 mol % to about 100% of the monomeric units of the polymer. In certain embodiments, the additional monomers may include about 0.1 mol % to about 90 mol % of the monomeric units of the polymer. In certain embodiments, the additional monomers may include about 0.1 mol % to about 70 mol % of the monomeric units of the polymer. The additional monomers may include, but are not limited to acrylamide, N-substituted acrylamides (such as 2-acrylamido-2-methylpropanesulfonic acid (AMPS), N-ethylacrylamide, N-isopropylacrylamide, N,N-dimethylacrylamide, N-hydroxyethylacrylamide, and, dimethylaminopropyl acrylamide), methacrylamide, N-substituted methacrylamides (such as dimethylaminopropyl methacrylamide), acrylates (such as methyl acrylate and hydroxyethyl acrylate), methacrylates (such as methyl methacrylate, 2-hydroxyethyl methacrylate, and 2-dimethylaminoethyl methacrylate), acrylic acid, methacrylic acid, N-vinylamides (such as N-vinylformamide, N-vinylacetamide, and N-methyl-N-vinylacetamide), N-allylamides, vinyl alcohol, vinyl ethers (such as vinyl ethyl ether, ethylene glycol monovinyl ether, polyethylene glycol monovinyl ether, and glycerol monovinyl ether), vinyl esters (such as vinyl acetate), allyl alcohol, allyl ethers (such as sodium 3-allyloxy-2-hydroxypropane-1-sulfonate, glycerol monoallyl ether, ethylene glycol monoallyl ether, and polyethylene glycol monoallyl ether), allyl esters (such as allyl acetate), vinylpyridine, vinyl sulfonates, allyl sulfonates, vinylimidazole, allylimidazole, and diallyldimethylammonium chloride.

The crosslinkers used in the methods and compositions of the present disclosure may include any suitable crosslinker. Examples of crosslinkers that may be suitable include one or more of the following crosslinkers: an acrylamide-based crosslinker, an acrylate-based crosslinker, an ester-based crosslinker, an amide-based crosslinker, divinyl ether, diallyl ether, vinyl or allyl ethers of polyglycols or polyols, divinylbenzene, 1,3-divinylimidazolidin-2-one (also known as 1,3-divinylethyleneurea or divinylimidazolidone), divinyltetrahydropyrimidin-2(1H)-one, dienes (such as 1,7-octadiene and 1,9-decadiene), allyl amines (such as triallylamine and tetraallylethylene diamine), N-vinyl-3(E)-ethylidene pyrrolidone, ethylidene bis(N-vinylpyrrolidone), and any derivative thereof, and any combination thereof.

In certain embodiments, an acrylamide-based crosslinker, an acrylate-based crosslinker, an ester-based crosslinker, and an amide-based crosslinker may be thermally unstable, and may hydrolyze at higher temperatures. In certain embodiments, divinyl ether, diallyl ether, vinyl or allyl ethers of polyglycols or polyols, divinylbenzene, 1,3-divinylimidazolidin-2-one (also known as 1,3-divinylethyleneurea or divinylimidazolidone), divinyltetrahydropyrimidin-2(1H)-one, dienes (such as 1,7-octadiene and 1,9-decadiene), allyl amines (such as triallylamine and tetraallylethylene diamine), N-vinyl-3(E)-ethylidene pyrrolidone, and ethylidene bis(N-vinylpyrrolidone) may serve as thermally stable crosslinkers, and may not hydrolyze at higher temperatures.

In certain embodiments, the acrylamide-based crosslinkers may be monomers with at least one acrylamide or methacrylamide group, which may also contain additional unsaturated groups such as vinyl, allyl, and/or acetylenic groups. In certain embodiments, the acrylate-based crosslinkers may be monomers with at least one acrylate or methacrylate group, which may also contain additional unsaturated groups such as vinyl, allyl, and/or acetylenic groups.

Examples of acrylamide-based crosslinkers that may be suitable in certain embodiments of the present disclosure include, but are not limited to, N,N′-methylenebisacrylamide, N,N′-methylenebismethacrylamide, N,N′-ethylenebisacrylamide, N,N′-(1,2-dihydroxyethylene)bisacrylamide, 1,4-diacryloylpiperazine, N,N-diallylacrylamide, and 1,3,5-triacryloylhexahydro-1,3,5-triazine. Examples of acrylate-based crosslinkers that may be suitable in certain embodiments of the present disclosure include, but are not limited to, ethylene glycol di(meth)acrylate, propylene glycol di(meth)acrylate, diethylene glycol di(meth)acrylate, polyethylene glycol di(meth)acrylate, 1,4-butanediol di(meth)acrylate, 1,6-hexanediol di(meth)acrylate, 1,1,1-trimethylolpropane trimethacrylate, pentaerythritol tri(meth)acrylate, pentaerythritol tetra(meth)acrylate, glycerol di(meth)acrylate, glycerol tri(meth)acrylate, triglycerol di(meth)acrylate, allyl (meth)acrylate, vinyl (meth)acrylate, tris[2-(acryloyloxy)ethyl]isocyanurate. Examples of ester-based and amide-based crosslinkers that may be suitable in certain embodiments of the present disclosure include, but are not limited to, vinyl or allyl esters (such as diallyl carbonate, divinyl adepate, divinyl sebacate, diallyl phthalate, diallyl maleate, diallyl succinate), 1,3,5-triallyl-1,3-5-triazine-2,4,6(1H,3H,5H)-trione, and triallyl cyanurate. Examples of vinyl or allyl ethers of polyglycols or polyols that may be suitable crosslinkers in certain embodiments of the present disclosure include, but are not limited to, pentaerythritol allyl ether (PAE), allyl sucrose, ethylene glycol divinyl ether, triethylene glycol divinyl ether, diethylene glycol divinyl ether, glycerol diallyl ether, and polyethylene glycol divinyl ether, propylene glycol divinyl ether, and trimethylolpropane diallyl ether.

In certain embodiments, the crosslinker may be present in a concentration of from about 0.05 mol % to 5 mol % of a total of the monomeric units of the polymer. In certain embodiments, the crosslinker may be present in a concentration of from about 0.1 mol % to 3 mol % of a total of the monomeric units of the polymer. In certain embodiments, the crosslinker may be present in a concentration of from about 1 mol % to 2 mol % of a total of the first monomeric units.

The treatment fluids of the present disclosure optionally may include any number of additional additives in combination with the crosslinked polymer composition. Other examples of such additional additives include, but are not limited to, salts, weighting agents, surfactants, emulsifiers, fluorides, fluid loss control additives, gas, nitrogen, carbon dioxide, surface modifying agents, tackifying agents, foamers, corrosion inhibitors, scale inhibitors, catalysts, clay control agents, biocides, friction reducers, antifoam agents, bridging agents, dispersants, flocculants, H₂S scavengers, CO₂ scavengers, oxygen scavengers, lubricants, breakers, relative permeability modifiers, resins, particulate materials (e.g., proppant particulates), wetting agents, coating enhancement agents, filter cake removal agents, additional viscosifying agents, and the like. One or more of these additives (e.g., bridging agents) may include degradable materials that are capable of undergoing irreversible degradation downhole. A person skilled in the art, with the benefit of this disclosure, will recognize the types of additives that may be included in the fluids of the present disclosure for a particular application.

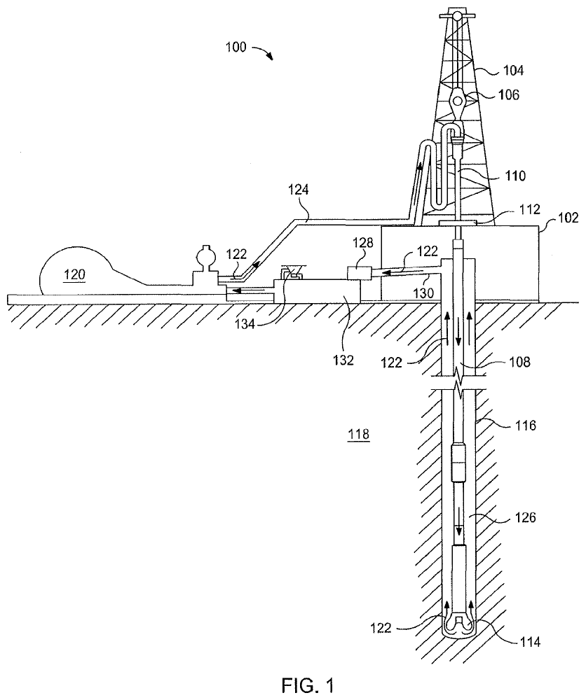

The compositions and treatment fluids of the present disclosure may be prepared by any suitable means known in the art. In some embodiments, the treatment fluids may be prepared at a well site or at an offsite location. In certain embodiments, a base fluid may be mixed with the polymer first, among other reasons, in order to allow the polymer to hydrate. Certain components of the fluid may be provided as a dry mix to be combined with fluid or other components prior to or during introducing the fluid into the well. Once prepared, a treatment fluid of the present disclosure may be placed in a tank, bin, or other container for storage and/or transport to the site where it is to be used. In other embodiments, a treatment fluid of the present disclosure may be prepared on-site, for example, using continuous mixing, on-the-fly mixing, or real-time mixing methods. In certain embodiments, these methods of mixing may include methods of combining two or more components wherein a flowing stream of one element is continuously introduced into flowing stream of another component so that the streams are combined and mixed while continuing to flow as a single stream as part of the on-going treatment. The system depicted in FIG. 1 (described below) may be one embodiment of a system and equipment used to accomplish on-the-fly or real-time mixing.

The methods and compositions of the present disclosure may be used during or in conjunction with any operation in a portion of a subterranean formation and/or wellbore, including but not limited to drilling operations, pre-flush treatments, after-flush treatments, hydraulic fracturing treatments, sand control treatments (e.g., gravel packing), “frac-pack” treatments, acidizing treatments (e.g., matrix acidizing or fracture acidizing), well bore clean-out treatments, cementing operations, workover treatments/fluids, and other operations where a treatment fluid may be useful. For example, the methods and/or compositions of the present disclosure may be used in the course of drilling operations in which a well bore is drilled to penetrate a subterranean formation. In certain embodiments, this may be accomplished using the pumping system and equipment used to circulate the drilling fluid in the well bore during the drilling operation, which is described below.

The treatment fluids of the present disclosure may be provided and/or introduced into the well bore or used to drill at least a portion of a well bore in a subterranean formation using any method or equipment known in the art. In certain embodiments, a treatment fluid of the present disclosure may be circulated in the well bore using the same types of pumping systems and equipment at the surface that are used to introduce drilling fluids and/or other treatment fluids or additives into a well bore penetrating at least a portion of the subterranean formation.

The methods and compositions disclosed herein may directly or indirectly affect one or more components or pieces of equipment associated with the preparation, delivery, recapture, recycling, reuse, and/or disposal of the disclosed compositions. For example, and with reference to FIG. 1, the disclosed methods and compositions may directly or indirectly affect one or more components or pieces of equipment associated with an exemplary wellbore drilling assembly 100, according to one or more embodiments. It should be noted that while FIG. 1 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a borehole 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the borehole 116. At the surface, the recirculated or spent drilling fluid 122 exits the annulus 126 and may be conveyed to one or more fluid processing unit(s) 128 via an interconnecting flow line 130. After passing through the fluid processing unit(s) 128, a “cleaned” drilling fluid 122 is deposited into a nearby retention pit 132 (i.e., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the scope of the disclosure.

One or more of the disclosed additives may be added to the drilling fluid 122 via a mixing hopper 134 communicably coupled to or otherwise in fluid communication with the retention pit 132. The mixing hopper 134 may include, but is not limited to, mixers and related mixing equipment known to those skilled in the art. In other embodiments, however, the disclosed additives may be added to the drilling fluid 122 at any other location in the drilling assembly 100. In at least one embodiment, for example, there could be more than one retention pit 132, such as multiple retention pits 132 in series. Moreover, the retention pit 132 may be representative of one or more fluid storage facilities and/or units where the disclosed additives may be stored, reconditioned, and/or regulated until added to the drilling fluid 122.

As mentioned above, the disclosed fluids and additives may directly or indirectly affect the components and equipment of the drilling assembly 100. For example, the disclosed fluids and additives may directly or indirectly affect the fluid processing unit(s) 128 which may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, any fluid reclamation equipment, or the like. The fluid processing unit(s) 128 may further include one or more sensors, gauges, pumps, compressors, and the like used store, monitor, regulate, and/or recondition the fluids.

The disclosed methods and compositions may directly or indirectly affect the pump 120, which representatively includes any conduits, pipelines, trucks, tubulars, and/or pipes used to fluidically convey the fluids and additives downhole, any pumps, compressors, or motors (e.g., topside or downhole) used to drive the fluids and additives into motion, any valves or related joints used to regulate the pressure or flow rate of the fluids and additives, and any sensors (i.e., pressure, temperature, flow rate, etc.), gauges, and/or combinations thereof, and the like. The disclosed fluids and additives may also directly or indirectly affect the mixing hopper 134 and the retention pit 132 and their assorted variations.

The disclosed methods and compositions also may directly or indirectly affect the various downhole equipment and tools that may come into contact with the compositions such as, but not limited to, the drill string 108, any floats, drill collars, mud motors, downhole motors and/or pumps associated with the drill string 108, and any MWD/LWD tools and related telemetry equipment, sensors or distributed sensors associated with the drill string 108. The disclosed methods and compositions may also directly or indirectly affect any downhole heat exchangers, valves and corresponding actuation devices, tool seals, packers and other wellbore isolation devices or components, and the like associated with the wellbore 116. The disclosed methods and compositions may also directly or indirectly affect the drill bit 114, which may include, but is not limited to, roller cone bits, PDC bits, natural diamond bits, any hole openers, reamers, coring bits, etc.

The disclosed methods and compositions also may directly or indirectly affect the various equipment and/or tools (not shown) used at a well site or in drilling assembly 100 to detect various events, properties, and/or phenomena. Such equipment and/or tools may include, but are not limited to, pressure gauges, flow meters, sensors (e.g., float sensors used to monitor the level of drilling fluid in retention pit 132, downhole sensors, sensors in return flow line 130, etc.), seismic monitoring equipment, logging equipment, and the like.

While not specifically illustrated herein, the disclosed methods and compositions may also directly or indirectly affect any transport or delivery equipment used to convey the compositions to the drilling assembly 100 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure and temperature), gauges, and/or combinations thereof, and the like.

To facilitate a better understanding of the present disclosure, the following examples of certain aspects of preferred embodiments are given. The following examples are not the only examples that could be given according to the present disclosure and are not intended to limit the scope of the disclosure or claims.

### EXAMPLES

In this example, a drill-in fluid formulation was mixed as shown in Table 1, wherein both a crosslinked N-vinylpyrrolidone (NVP) polymer and nanocellulose were used. It should be understood that the formulation shown in Table 1 is merely exemplary of many types of fluids that can be made according to the invention.

TABLE 1
Formulation with Crosslinked PVP and nanocellulose

| | Time | | |
|---|---|---|---|
| Component | (min) | Amount | |
| 14.2 ppg | 1 | 0.848 | bbl |
| CaBr₂ Brine | | | |
| Water | 1 | 0.08 | bbl |
| Defoamer | 1 | 0.2 | ppb |
| Alkalinity Agent | 1 | 0.5 | ppb |
| Crosslinked | 10 | 6 | ppb |
| NVP Polymer | | | |
| Nanocellulose | 10 | 0-1 | ppb |
| Calcium | 5 | 40 | ppb |
| Carbonate | | | |

After the fluid was mixed, the rheology data before hot rolling was obtained at 49° C. (120° F.) with FANN™ Model 45 viscometer. The effect of adding nanocellulose to the synthetic polymers on the rheology of the fluids is shown in the data in Table 2. The results in Table 2 shows that the addition of nanocellulose increased the initial fluid rheology, especially the low-shear-rate rheology at 6 rpm and 3 rpm, which may help prevent the settling of solid particles like calcium carbonate.

TABLE 2
Rheology measurements for Crosslinked PVP system with
different concentrations of nanocellulose added

| Shear | PVP | PVP + | PVP + | PVP + | PVP + | PVP + |
|---|---|---|---|---|---|---|
| Rate | (Base) | 1 ppb NC | 0.8 ppb NC | 0.7 ppb NC | 0.6 ppb NC | 0.5 ppb NC |
| 600 | 45 | 90 | 84 | 84 | 75 | 75 |
| 300 | 28 | 59 | 57 | 56 | 48 | 44 |
| 200 | 20 | 46 | 46 | 43 | 37 | 32 |
| 100 | 13 | 32 | 32 | 28 | 23 | 18 |
| 6 | 2 | 10 | 10 | 8 | 5 | 2 |
| 3 | 2 | 8 | 9 | 6 | 4 | 1 |
| 10 sec | 1 | 9 | 9 | 7 | 4 | 0 |
| 10 min | 2 | 16 | 15 | 11 | 7 | 3 |
| PV | 17 | 32 | 27 | 28 | 28 | 31 |
| Tau 0 | 0.28 | 5.99 | 5.25 | 3.60 | 1.72 | 0.46 |
| YP | 11 | 27 | 30 | 27 | 20 | 13 |

The fluid sample with 1 lb/bbl (ppb) of nanocellulose was then static aged at 356° F. for 24 hours. Table 3 shows the rheology data obtained by the FANN™ Model 45 viscometer for the polymer with and without nanocellulose after static aging.

TABLE 3
Rheology of Crosslinked PVP system
with and without nanocellulose

| | PVP (Base) | | | PVP + 1 ppb NC | | |
|---|---|---|---|---|---|---|
| | | AHR | Static Oven | | AHR | Static Oven |
| Shear | | (16 hrs | (24 hrs | | (16 hrs | (24 hrs |
| Rate | BHR | 150° F.) | 356° F.) | BHR | 150° F.) | 356° F.) |
| 600 | 45 | 54 | 107 | 90 | 104 | 84 |
| 300 | 28 | 33 | 71 | 59 | 74 | 53 |
| 200 | 20 | 25 | 55 | 46 | 59 | 39 |
| 100 | 13 | 15 | 34 | 32 | 42 | 26 |
| 6 | 2 | 2 | 6 | 10 | 15 | 4 |
| 3 | 2 | 2 | 4 | 8 | 14 | 4 |
| 10 sec | 1 | 2 | 4 | 9 | 14 | 3 |
| 10 min | 2 | 2 | 6 | 16 | 22 | 8 |
| PV | 17 | 20 | 36 | 32 | 30 | 31 |
| Tau 0 | 0.28 | 0.33 | 0.72 | 5.99 | 7.41 | 0.53 |
| YP | 11 | 13 | 35 | 27 | 45 | 23 |

Table 3 shows that the inclusion of nanocellulose with the synthetic polymer increases the rheology of the fluid as compared to the synthetic polymer alone at lower temperatures but does not significantly affect the rheology of the fluid at higher temperatures after the nanocellulose degrades.

An embodiment of the present disclosure is a method including: providing a treatment fluid that includes: a base fluid, a synthetic crosslinked polymer composition including a plurality of monomeric units, and at least one crosslinker; and nanocellulose. The treatment fluid is introduced to at least a portion of a well bore penetrating at least a portion of a subterranean formation. In one or more of the preceding embodiments, the plurality of monomeric units is at least one N-vinyl lactam monomeric unit. In one or more of the preceding embodiments, the synthetic crosslinked polymer composition is a homopolymer. In one or more of the preceding embodiments, the treatment fluid further includes calcium carbonate. In one or more of the preceding embodiments, the nanocellulose is allowed to at least partially degrade upon exposure to heat within the well bore. In one or more of the preceding embodiments, the nanocellulose is selected from the group consisting of: nanofibrillar cellulose, nanocrystalline cellulose, bacterial nanocellulose, any derivative thereof, and any combination thereof. In one or more of the preceding embodiments, the base fluid is a divalent brine. In one or more of the preceding embodiments, the divalent brine

What is claimed is:

1. A method comprising:
providing a treatment fluid that comprises:
a base fluid;
a synthetic crosslinked polymer composition comprising a plurality of monomeric units, and at least one crosslinker;
a nanocellulose; and
introducing the treatment fluid into at least a portion of a well bore penetrating at least a portion of a subterranean formation.

2. The method of claim 1 wherein the plurality of monomeric units comprise at least one N-vinyl lactam monomeric unit.

3. The method of claim 1 wherein the synthetic crosslinked polymer composition comprises a homopolymer.

4. The method of claim 1 wherein the treatment fluid further comprises calcium carbonate.

5. The method of claim 1, further comprising allowing the nanocellulose to at least partially degrade upon exposure to heat within the well bore.

6. The method of claim 1 wherein the nanocellulose is selected from the group consisting of: nanofibrillar cellulose, nanocrystalline cellulose, bacterial nanocellulose, any derivative thereof, and any combination thereof.

7. The method of claim 1 wherein the base fluid comprises a divalent brine.

8. The method of claim 7 wherein the divalent brine is selected from the group consisting of: a calcium bromide brine, a calcium chloride brine, and any combination thereof.

9. The method of claim 1 wherein the crosslinker is selected from the group consisting of: an acrylamide-based crosslinker, an acrylate-based crosslinker, an ester-based crosslinker, an amide-based crosslinker, divinyl ether, diallyl ether, vinyl or allyl ethers of polyglycols or polyols, divinylbenzene, 1,3-divinylimidazolidin-2-one, divinyltetrahydropyrimidin-2(1H)-one, dienes, allyl amines, N-vinyl-3(E)-ethylidene pyrrolidone, ethylidene bis(N-vinylpyrrolidone), any derivative thereof, and any combination thereof.

10. The method of claim 1 wherein the crosslinker comprises pentaerythritol ally ether.

11. A method comprising:
providing a treatment fluid that comprises:
a divalent brine base fluid;
a synthetic crosslinked polymer composition comprising at least one homopolymer that comprises at least one N-vinyl lactam monomeric unit, and at least one crosslinker;
a nanocellulose; and
introducing the treatment fluid into at least a portion of a well bore penetrating at least a portion of a subterranean formation.

12. The method of claim 11 wherein the homopolymer comprises polyvinylpyrrolidone.

13. The method of claim 11 wherein the treatment fluid further comprises calcium carbonate.

14. The method of claim 11 further comprising allowing the nanocellulose to at least partially degrade upon exposure to heat within the well bore.

15. The method of claim 14 wherein the nanocellulose at least partially degrades around 325° F.

16. The method of claim 11 wherein the nanocellulose is selected from the group consisting of: nanofibrillar cellulose, nanocrystalline cellulose, bacterial nanocellulose, any derivative thereof, and any combination thereof.

17. The method of claim 11 wherein the crosslinker is selected from the group consisting of: an acrylamide-based crosslinker, an acrylate-based crosslinker, an ester-based crosslinker, an amide-based crosslinker, divinyl ether, diallyl ether, vinyl or allyl ethers of polyglycols or polyols, divinylbenzene, 1,3-divinylimidazolidin-2-one, divinyltetrahydropyrimidin-2(1H)-one, dienes, allyl amines, N-vinyl-3(E)-ethylidene pyrrolidone, ethylidene bis(N-vinylpyrrolidone), any derivative thereof, and any combination thereof.

18. The method of claim 11 wherein the crosslinker comprises pentaerythritol ally ether.

19. The method of claim 11 wherein the divalent brine is selected from the group consisting of: a calcium bromide brine, a calcium chloride brine, and any combination thereof.

20. A method comprising:
providing a drilling fluid that comprises:
a divalent brine base fluid comprising a calcium bromide brine;
a synthetic crosslinked polymer composition comprising at least one homopolymer comprising polyvinylpyrrolidone, and at least one crosslinker comprising pentaerythritol ally ether;
a nanofibrillar cellulose;
calcium carbonate; and
introducing the drilling fluid into to at least a portion of a well bore penetrating at least a portion of a subterranean formation; and
allowing the nanocellulose to at least partially degrade upon exposure to heat within the well bore.
